(19) United States
(12) Patent Application Publication
(10) Pub. No.: US 2026/0059152 A1
(43) Pub. Date: Feb. 26, 2026

(54) METHODS AND APPARATUS TO PERFORM DYNAMIC ADVERTISEMENT INSERTION IN MEDIA STREAMS

(71) Applicant: DIRECTV, LLC, El Segundo, CA (US)

(72) Inventors: D. Edward Cook, Birch Run, MI (US); Jed S. Smith, Peachtree City, GA (US); Scott G. Crawford, Leland, NC (US); Rajesh Krishna, Cerritos, CA (US)

(21) Appl. No.: 18/811,523

(22) Filed: Aug. 21, 2024

(51) Int. Cl. H04N 21/234; G06Q 30/0273

(52) U.S. Cl. CPC H04N 21/23424; G06Q 30/0275

(57) ABSTRACT

Disclosed examples include accessing a request corresponding to a set-top-box, the request received during receipt of a media stream at the set-top-box, the request to cause selection of an advertisement, the advertisement to be presented by the set-top-box during the media stream; accessing a break descriptor from the request, the break descriptor corresponding to a break in the media stream; based on the break descriptor, enabling the selection of the advertisement for the break of the media stream; and triggering generation of an advertisement decision for the set-top-box in association with the break descriptor, the advertisement decision to represent the advertisement.

### FIELD OF THE DISCLOSURE

This disclosure relates generally to media distribution systems and, more particularly, to methods and apparatus to perform dynamic advertisement insertion in media streams.

### BACKGROUND

In media distribution systems such as television broadcast systems and on-demand media services, advertisements can be delivered with content. Upon receiving a media stream, a media presentation device can present the content and the advertisements during breaks in the content. In this manner, when audience members access the content, this creates an opportunity to also present advertisements to those audience members.

### BRIEF DESCRIPTION OF THE DRAWINGS

FIG. 1 is a block diagram of an example environment in which an example dynamic advertisement insertion (DAI) break enabler operates to enable dynamic advertisement selection for advertisement breaks in media streams.

FIG. 2 shows the DAI break enabler of FIG. 1 in communication with an example DAI schedule database to enable dynamic advertisement selection for advertisement breaks in a media stream.

FIG. 3 is a block diagram of an example implementation of the DAI break enabler of FIGS. 1 and 2.

FIG. 4 is a block diagram of an example implementation of the set-top-box (STB) of FIG. 1.

FIG. 5 is a flowchart representative of example machine-readable instructions and/or example operations that may be executed, instantiated, and/or performed by example programmable circuitry to implement the DAI break enabler of FIG. 3.

FIG. 6 is a flowchart representative of example machine-readable instructions and/or example operations that may be executed, instantiated, and/or performed by example programmable circuitry to implement the STB of FIG. 4.

FIG. 7 is a block diagram of an example processing platform including programmable circuitry structured to execute, instantiate, and/or perform the example machine-readable instructions and/or perform the example operations of FIGS. 5 and/or 6 to implement the DAI break enabler of FIG. 3 and/or the STB of FIG. 4.

FIG. 8 is a block diagram of an example implementation of the programmable circuitry of FIG. 7.

FIG. 9 is a block diagram of another example implementation of the programmable circuitry of FIG. 7.

In general, the same reference numbers will be used throughout the drawings and accompanying written description to refer to the same or like parts. The figures are not necessarily to scale.

### DETAILED DESCRIPTION

Examples disclosed herein may be used to implement a dynamic advertisement insertion (DAI) system to operate in a content stream environment in which different tier-level advertisements (ads) are used. In examples disclosed herein, tier-level advertisements include Tier-3 (T3) level advertisements, Tier-2 (T2) level advertisements, and Tier-1 (T1) level advertisements. Each of the T3-level, T2-level, and T1-level ads has a different level of relevancy to audiences of programming content. For example, as described in detail below, a T3-level ad (e.g., a T3-level ad creative) is generally relevant to an audience based on characteristics of concurrently presented programming content, a T1-level ad (e.g., a T1-level ad creative) is regionally relevant based on an audience's geographic region, and a T2-level ad (e.g., a T2-level ad creative) is user-level and/or household-level relevant to an audience member.

As used herein, programming content, or content, refers to primary media in a stream or broadcast such as television shows, program episodes, movies, news, music, etc. As used herein, an advertisement is secondary media in the stream or broadcast presented at different time allocations between segments of primary media in a corresponding media stream. Purchasers (e.g., manufacturers, retailers, service providers, political parties, etc.) of advertisement time pay an agreed upon price for ad spots in media streams. Such financial payments can be used by media networks to support or sponsor delivery of the programming content in the media streams.

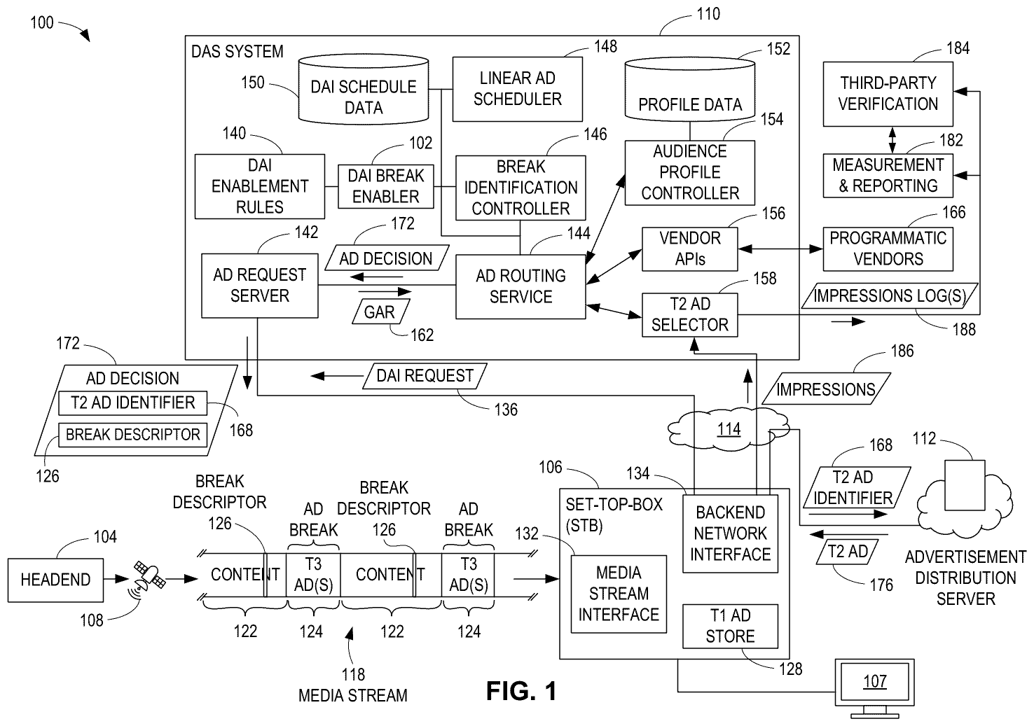

FIG. 1 is a block diagram of an example media distribution system 100 in which an example DAI break enabler 102 operates to enable dynamic ad selection for ad breaks in media streams. The media distribution system 100 includes an example headend system 104 in communication with a set-top-box (STB) 106 via a media distribution network such as a satellite network 108 or any other suitable type of media distribution network. The media distribution system 100 also includes an example dynamic ad selection (DAS) system 110 and an example advertisement distribution server 112 (e.g., a network resource) in communication with the STB 106 via a wide-area network (WAN) or a global network such as the Internet 114.

In examples disclosed herein, the headend 104 generates media streams for delivery to the STB 106, and the STB 106 presents the media streams at an audience location of the STB 106. For example, the STB 106 is connected to an example television or video monitor 107 and sends display information (e.g., video data, image data, text data, etc.) to the television or video monitor 107 to present the media streams. Also in examples disclosed herein, the DAS system 110 includes the DAI break enabler 102 to enable dynamic ad selection for ad breaks in the media streams. Upon enablement of dynamic ad selection by the DAI break enabler 102, the DAS system 110 also selects ads based on user-level profile information and/or household-level profile information to be presented by the STB 106. Also in examples disclosed herein, the advertisement distribution server 112 stores advertisements selected by the DAS system 110. After the STB 106 receives a selected ad identifier from the DAS system 110, the STB 106 uses a uniform resource locator (URL) of the advertisement distribution server 112 to send the ad identifier to the advertisement distribution server 112 to retrieve the ad corresponding to the selected ad identifier. In some examples, the advertisement distribution server 112 may be implemented using a cloud-based content distribution network (CDN).

The STB 106 is at a subscriber location (e.g., a residence, a business, a school, etc.). The headend system 104 transmits an example media stream 118 to the STB 106. The media stream 118 is a real-time feed that includes example content segments 122 and example ad break segments 124. The content segments 122 include programming content such as television shows, program episodes, movies, news, music, etc. The ad break segments 124 are provided to present ads via the STB 106. The media stream 118 also includes example break descriptors 126 (e.g., break text descriptors) co-located with the content segments 122 in a manner that the break descriptors 126 are not perceivable by an audience of the media stream 118. Each break descriptor 126 includes a unique ad break identifier that uniquely identifies a corresponding one of the ad breaks 124 that is upcoming in the media stream 118.

The headend system 104 inserts T3-level advertisements in the advertisement breaks 124 of the media stream 118. In examples disclosed herein, T3-level advertisements are linear advertisements in that they are scheduled with corresponding content programming and transmitted in line with the media stream 118 by the headend system 104. As used herein, T3-level advertisements are non-targeted based on individual audience profiles but are deemed generally relevant to audiences expected to tune in to concurrently scheduled programming content. For example, if the content 122 includes a prime time news stream, the corresponding ad breaks 124 will include T3-level ads relevant to an audience interested in the prime time news stream. That is, the T3-level ads are scheduled linearly with the prime time news stream based on characteristics of the prime time news stream and a general audience to which those characteristics appeal instead of user-level or household-level characteristics of individual audience members.

In the example of FIG. 1, the headend system 104 provides T1-level ads to the STB 106 in advance of media streams with which the T1-level ads are to be presented. The STB 106 includes an example T1-level ad store 128 that stores the T1-level ads. For example, the T1-level ad store 128 can store multiple T1-level ads from which the STB 106 can select to present in place of or as substitutes for the linear T3-level ads populated in the media stream 118 at the headend system 104. T1-level ads are more-targeted advertisements that have a greater level of relevancy to audiences at corresponding STBs based on geographic regions of those audiences. For example, T1-level ads are STB-addressable ads that can be targeted on a per-region basis to particular STBs (e.g., based on their respective network addresses). As such, a T1-level ad could be distributed in a manner that makes it geographically relevant to an audience in a particular region in which a STB is located. For example, T1-level ads could be used to advertise for local businesses in a geographic region.

When signaled by the headend system 104, the STB 106 may replace or overlay a T3-level ad at an ad break 124 with a locally queued T1-level ad from the T1 ad store 128. The STB 106 can select a locally queued T1-level ad based on one or more locally enforced rules. For example, the STB 106 may refer to locally stored rules about frequency of presentation (e.g., over-presented or under-presented) for different T1-level ads, times of day of when to present T1-level ads, etc.

In examples disclosed herein, the STB 106 includes an example media stream interface 132 and an example backend network interface 134. The media stream interface 132 connects the STB 106 to the headend system 104 via the satellite network 108. The backend network interface 134 connects the STB 106 to an example DAS system 110 via a wide-area network (WAN) or a global network such as the Internet 114. In example FIG. 1, the DAS system 110 is a backend system separate from the headend system 104. For example, the headend system 104 delivers the media stream 118 and default linear T3-level advertisements to the STB 106 via a first network (e.g., the satellite network 108) and the DAS system 110 delivers ad decisions (e.g., the ad decision 172) on dynamic ad selection of T2-level ads to the STB 106 via a separate, second network (e.g., a WAN or the Internet 114).

During receipt of the media stream 118 at the STB 106 from the headend system 104 via the media stream interface 132, the STB 106 sends an example DAI request message 136 to the DAS system 110 via the backend network interface 134. The DAI request 136 causes the DAS system 110 to determine whether to enable dynamic ad selection of a T2-level ad for an upcoming one of the ad breaks 124 in the media stream 118. By enabling or disabling dynamic ad selection of a T2-level ad at the DAS system 110 for an ad break 124 in the media stream 118, examples disclosed may be used to provide a third type of advertisement selection technology. For example, while T3-level ads are deemed generally relevant to an audience based on characteristics of the content 122 and T1-level ads can be targeted based on a geographic region of the STB 106, T2-level ads can be selected based on user-level profiles and/or household-level profiles of audience members. For example, the DAS system 110 can store user-level audience profile information (and/or household-level audience profile information) such as demographics, media preferences, product preferences, and media access histories (e.g., viewing histories) specific to audience members associated with different STBs. In this manner, the DAS system 110 can select a T2-level ad that is substantially more user-level relevant and/or household-level relevant to an audience (e.g., one or more audience members) than a T3-level ad or a T1-level ad. In addition, selection of a T2-level ad at the DAS system 110 allows reducing the storage capacity of the T1 ad store 128 used at the STB 106 to store T1-level ads and allows reducing the amount of network bandwidth used to periodically update the locally stored T1-level ads at the STB 106. For example, more T2-level ads can be stored at a network resource (e.g., the advertisement distribution server 112) and updated more frequently at that network resource without using large amounts of network capacity to pre-download the ads to the numerous STBs leased out by a media network operator.

To enable and perform dynamic ad selection, the DAS system 110 includes multiple subsystems. For example, the DAS system 110 includes the example DAI break enabler 102, an example DAI enablement rules database 140, an example ad request server 142, an example ad routing service 144, an example break identification controller 146, an example linear ad scheduler 148, an example DAI schedule database 150, an example profile database 152, an example audience profile controller 154, example vendor application programming interfaces (APIs) 156, and an example T2 ad selector 158.

The ad request server 142 operates as an interface of the DAS system 110 to communicate with STBs such as the STB 106. For example, the ad request server 142 receives the DAI request 136 from the STB 106 via the Internet 114. After receipt of the DAI request 136, the ad request server 142 converts the DAI request 136 to an example general ad request (GAR) 162. As such, the ad request server 142 also operates as an ad request translation service to receive DAI requests in different formats from different STBs and to convert the received DAI requests into the GAR 162 in a format that can be processed by other subsystems of the DAS system 110.

The GAR 162 enables the ad routing service 144 to access requests from multiple different types of requesting entities (e.g., STBs associated with different media service providers), without burdening the ad routing service 144 with overhead associated with having to process information/data associated with the details of a particular type of requesting entity. In some examples, the GAR 162 includes three fields, referred to herein as: (1) a key, (2) a base object, and (3) an extension object. Each of these three fields may include parameters/sub-fields as described in further detail below.

The key may identify a particular requesting entity (e.g., the STB 106) and/or a particular vendor/service provider (e.g., the ad routing service 144). The base object may include one or more of: (1) a network identifier, (2) an application identifier, (3) a session identifier, (4) a platform identifier, (5) an address identifier (e.g., an Internet protocol (IP) address), (6) location coordinates, (7) an advertising type, (8) a stream identifier, and/or (9) a call back time parameter. The extension object may include: (1) an ad decision server (ADS) parameter (e.g., if the DAS system 110 does not derive the ADS from the key), and (2) one or more pass-through attributes. A pass-through attribute may include one or more parameters that may be used by the ad routing service 144 identified by the key. That is, the ad request server 142 may transfer pass-through attributes of the extension object in an unadulterated form, such as the break descriptors 126, from the STB 106 to the ad routing service 144.

The GAR 162 causes the DAS system 110 to determine whether to enable dynamic ad selection for an upcoming one of the ad breaks 124 in the media stream 118. For example, the DAI request 136 includes an audience identifier (e.g., a publisher-provided identifier (PPid)) associated with the STB 106 and one of the break descriptors 126 corresponding to an upcoming one of the ad breaks 124 in the media stream 118. The ad request server 142 places the audience identifier and the break descriptor 126 in the GAR 162. In response to the GAR 162, the ad routing service 144 provides the break descriptor 126 to the break identification controller 146. The break identification controller 146 identifies the upcoming ad break 124 in the media stream 118 based on the break descriptor 126. For example, the break descriptor 126 includes a break identifier indicative of the upcoming ad break 124.

The linear ad scheduler 148 provides linear ad schedules of the ad breaks 124 in the media stream 118 in which the headend system 104 inserts the default linear type T3-level ads. The linear ad schedules include dates and times during which the ad breaks 124 occur in the media stream 118 for the different television channels offered by the headend 104. In some examples, the linear ad scheduler 148 obtains the linear ad schedules from the headend system 104. In other examples, the linear ad scheduler 148 obtains the linear ad schedules from one or more other parties (e.g., content providers of different television channels) that create the linear ad schedules and/or programming content schedules for the headend system 104. In yet other examples, users enter the linear ad schedule information into the linear ad scheduler 148 based on information received from the headend 104 and/or other parties.

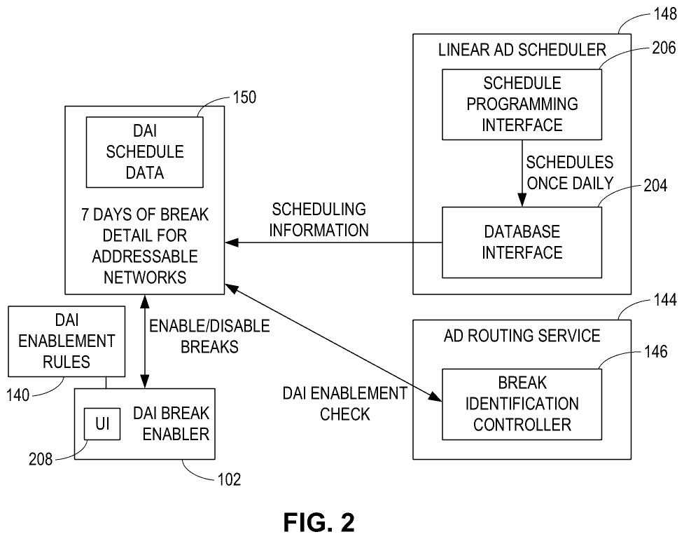

The DAI enablement rules database 140 is provided to store DAI enablement rules created by an ad scheduling team. The DAI enablement rules in the DAI enablement rules database 140 are indicative of which of the ad breaks 124 in the media stream 118 are to be enabled for dynamic ad selection (e.g., dynamic ad insertion). Additional details of how rules are created in the DAI enablement rules database 140 are described below in connection with FIG. 2.

The DAI break enabler 102 accesses ad schedule information corresponding to break identifiers in the DAI schedule database 150. The schedule information in the DAI schedule database 150 includes break identifiers of the different ad breaks 124. When a break descriptor 126 is received at the DAS system 110, the DAI break enabler 102 locates the break descriptor 126 in the schedule information and analyzes the schedule information relative to rules in the DAI enablement rules database 140. Based on this analysis, the DAI break enabler 102 determines whether to enable or disable dynamic ad selection (e.g., dynamic ad insertion) of a T2-level ad for a corresponding upcoming ad break 124 corresponding to the break descriptor 126 based on the DAI enablement rules.

The DAI break enabler 102 updates the DAI schedule database 150 to include a dynamic ad selection enable decision for the upcoming ad break 124. For example, if the DAI break enabler 102 determines that one or more rules in the DAI enablement rules database 140 indicates that a T2-level ad is to be presented for the ad break 124, the DAI break enabler 102 sets the corresponding tier-level indicator to a T2-level ad type in association with a break identifier of that ad break 124 in the DAI schedule database 150. This indicator setting in the DAI schedule database 150 allows for the enabling of dynamic ad selection of a T2-level ad for that ad break 124. In some examples, through this updating, the DAI break enabler 102 stores codes or values as T2 tier-level indicators in association with different ad breaks 124 to indicate the ad selection enable decision to present a T2 tier-level ad type during those ad breaks 124. The break identification controller 146 retrieves the dynamic ad selection enable decision from the DAI schedule database 150 and provides the dynamic ad selection enable decision to the ad routing service 144.

If the dynamic ad selection enable decision generated by the DAI break enabler 102 indicates that dynamic ad selection is enabled for the upcoming ad break 124, the ad routing service 144 obtains audience profile information from the audience profile controller 154 and obtains a T2 ad campaign identifier from a vendor API 156, as described below, so that the T2 ad selector 158 can select a T2-level ad to be presented by the STB 106 instead of (e.g., as a substitute for) the T3-level ad at the upcoming ad break 124. For example, the profile database 152 stores user-level audience profile information (and/or household-level audience profile information) such as demographics, media preferences, product preferences, and media access histories (e.g., viewing histories) specific to audience members associated with different STBs. The audience profile controller 154 uses the audience identifier received in the GAR 162 to access corresponding audience profile information associated with the STB 106 from the profile database 152 and provides the audience profile information to the ad routing service 144.

The ad routing service 144 generates an ad opportunity notification that includes the audience profile information associated with the STB 106 and sends the ad opportunity notification to the vendor APIs 156. In example FIG. 1, the vendor APIs 156 are instantiated to communicate with multiple example programmatic vendors 166. The programmatic vendors 166 are ad spot brokers that negotiate sales of available ad spot opportunities in media streams (e.g., the media stream 118) with potential ad spot purchasers (e.g., manufacturers, retailers, service providers, political parties, etc.).

In example FIG. 1, the programmatic vendors 166 provide the audience profile information from the ad opportunity notification to the potential ad spot purchasers. The potential ad spot purchasers can determine whether their ad campaigns align with an audience associated with the STB 106 based on the audience profile information. As such, the potential ad spot purchasers can purchase ad spots to target their advertisements at the user level for different audience members associated with different STBs. When an ad spot purchaser purchases an ad spot for the upcoming ad break 124, the ad spot purchaser selects one of its ad campaign identifiers corresponding to an ad campaign that aligns with the audience profile information. The ad campaign can include one or more ads relevant to the audience profile information. In some examples, the programmatic vendors 166 use auction systems for ad spot purchasers to bid on available ad spot opportunities based on audience profile information associated with STBs so that their corresponding advertisements are presented by the STBs.

After a programmatic vendor 166 finds an ad spot purchaser that agrees to purchase the ad spot corresponding to the upcoming ad break 124, a corresponding vendor API 156 reports the match between the ad spot purchaser and the upcoming ad break 124 to the ad routing service 144. The match reporting can include an ad campaign identifier from the ad spot purchaser. The ad routing service 144 sends the ad campaign identifier to the T2 ad selector 158. The T2 ad selector 158 selects a T2-level ad corresponding to the ad campaign identifier. For example, the T2 ad selector 158 may select the T2-level ad (e.g., a T2-level ad creative) based on one or more criteria such as time of day, frequency of presentation, duration since last selection, etc. The T2 ad selector 158 provides the ad routing service 144 an example T2-level ad identifier 168 corresponding to the selected T2-level ad. In some examples, the T2 ad selector 158 may be implemented by an ad selection service such as the Freewheel technology platform of New York, New York, United States of America.

The ad routing service 144 generates an example ad decision 172. For instances in which the DAI break enabler 102 enables dynamic ad selection for the upcoming ad break 124, the ad routing service 144 includes the T2-level ad identifier 168 and the break descriptor 126 in the ad decision 172, as shown in FIG. 1. Alternatively, for instances in which the DAI break enabler 102 does not enable dynamic ad selection for the upcoming ad break 124, the ad routing service 144 includes a code or value in the ad decision 172 indicative that the STB 106 is to present a T3-level ad or a T1-level ad for the upcoming ad break 124.

The ad routing service 144 provides the ad decision 172 to the ad request server 142, and the ad request server 142 sends the ad decision 172 to the STB 106 via the Internet 114. The STB 106 receives the ad decision 172 via the backend network interface 134. To present a selected T2-level ad at the upcoming ad break 124, the STB 106 sends the T2-level ad identifier 168 to the advertisement distribution server 112. The advertisement distribution server 112 retrieves one or more media file(s) for a T2-level ad 176 (e.g., a T2-level ad creative 176) corresponding to the T2-level ad identifier 168 and sends the media file(s) for the T2-level ad 176 to the STB 106. The STB 106 decodes the T2 ad media file(s) and presents the corresponding T2-level ad 176.

In example FIG. 1, the T2 ad selector 158 is in communication with an example measurement and reporting platform 182 and an example third-party verification platform 184. After ad presentations by the STB 106, the STB 106 reports corresponding impression notifications 186 to the T2 ad selector 158 via the Internet 114 using the backend network interface 134. As used herein, an impression is the occurrence of an ad presentation via a STB such as the STB 106. The impression is representative of an opportunity for one or more audience members to be exposed to the presented ad. The T2 ad selector 158 logs the impression notifications 186 in one or more impressions log(s) 188 and sends the impressions log(s) 188 to the measurement and reporting platform 182 and/or the third-party verification platform 184. The measurement and reporting platform 182 performs analytics on the impressions log(s) 188. The third-party verification platform 184 is a neutral third-party that confirms accuracies of the impressions reported in the impressions log(s) 188.

FIG. 2 shows the DAI break enabler 102 in communication with the DAI enablement rules database 140 and the DAI schedule database 150 of FIG. 1 to enable dynamic ad selection for the advertisement breaks 124 in the media stream 118 of FIG. 1. In example FIG. 2, the break identification controller 146 is located in the ad routing service 144. Alternatively, the break identification controller 146 may be separate from the ad routing service 144. Also in example FIG. 2, the linear ad scheduler 148 includes an example database interface 204 and an example schedule programming interface 206. In some examples, the linear ad scheduler 148 is implemented using a WideOrbit platform provided by WideOrbit of San Francisco, California, United States of America.

The linear ad scheduler 148 is provided with the schedule programming interface 206 to obtain linear ad schedules from the headend system 104 (FIG. 1), other parties (e.g., content providers of different television channels), and/or users, as described above in connection with FIG. 1. As noted above in connection with FIG. 1, the linear ad schedules include dates and times during which the ad breaks 124 occur in the media stream 118 of FIG. 1 for different television channels offered by the headend 104. The linear ad scheduler 148 uses the database interface 204 to communicate with the DAS schedule database 150. For example, linear ad schedule information can be received by the linear ad scheduler 148 via the schedule programming interface 206, and the schedule programming interface 206 provides the linear ad schedule information to the database interface 204. In turn, the database interface 204 sends the linear ad schedule information to the DAI schedule database 150. Example FIG. 2 shows linear ad schedule information provided by the schedule programming interface 206 to the database interface 204 once daily. However, any other frequency of providing or updating schedule information may be used instead.

The DAI break enabler 102 is provided with an example DAI user interface (UI) 208 as part of a scheduling application to create, edit, delete, etc. DAI enablement rules in the DAI enablement rules database 140. In some examples, the DAI UI 208 is a webpage interface that communicates with the DAI enablement rules database 140 via an API. The DAI break enabler 102 uses the DAI enablement rules to make dynamic ad selection enable decisions to present T2-level ads for ones of the ad breaks 124 in the media stream 118. For example, an ad scheduling team can use the DAI UI 208 to provide DAI enablement rules indicative of which ad breaks (e.g., ones of the ad breaks 124 of FIG. 1) in media streams (e.g., the media stream 118 of FIG. 1) to enable for dynamic ad selection of T2-level ads to be presented by STBs instead of (e.g., as substitutes for) linear T3-level ads.

In some examples, the ad scheduling team may create such DAI enablement rules based on different monetization goals for different ones of the T3, T2, and T1 advertisement tiers. For example, the ad scheduling team can create DAI enablement rules to configure multi-tier ad schedules that evenly distribute ad presentations across all three ad tiers over a 24-hour period or over multiple days. Alternatively, the ad scheduling team can create DAI enablement rules that prioritize one or two of the ad tiers for more ad presentations over the other tier(s). In some examples, the ad scheduling team configures DAI enablement rules to control how much storage capacity is used in the T1 ad store 128 to locally store T1-level ads in the STB 106. For example, the DAI enablement rules in the DAI enablement rules database 140 may be configured to decrease the amount of local storage capacity consumed by T1-level ads in the T1 ad store 128.

In yet other examples, the ad scheduling team creates rules for ad breaks 124 based on one or more of television channels, programming contents, dates, times, etc. For example, the ad scheduling team may create a rule that ad breaks 124 on a particular television channel and/or during particular programming content during a specified time range on one or more dates (e.g., between the hours of 6:00 PM and 10:00 PM during one or more particular days of the week and/or one or more dates) are to be enabled for dynamic ad selection of T2-level ads. In any case, the ad scheduling team uses the DAI UI 208 of the DAI break enabler 102 to store the DAI enablement rules in the DAI enablement rules database 140 for future use by the DAI break enabler 102 when a break descriptor 126 is received at the DAS system 110 in advance of an ad break 124. As such, the DAI break enabler 102 uses the DAI enablement rules to selectively enable ones of the ad breaks 124 of the media stream 118 for presentations of T2-level ads based on any suitable criteria selected by the ad scheduling team (e.g., television channel, programming content, dates, days of the week, times of day, amount of storage capacity used in the T1 ad store 128, ad tier distributions, prioritizations of ad tiers, rate or frequency of presentation of T2-level ads or other tier-level ads over time, etc.).

In example FIG. 2, the DAI schedule database 150 is shown as storing seven days of break detail for addressable networks. In other examples, the DAI schedule database 150 may store fewer or more days of break detail. In the illustrated example of FIG. 2, addressable networks refer to media distribution networks in which STBs in those networks are individually addressable with unique addresses.

The DAI break enabler 102 uses the linear ad schedule information in the DAI schedule database 150 to identify ad breaks (e.g., the ad breaks 124 of FIG. 1) and uses the DAI enablement rules in the DAI enablement rules database 140 to determine ones of the ad breaks 124 for which to enable or disable (e.g., not enable) dynamic ad selection of T2-level ads. For example, the DAI break enabler 102 uses a break identifier from a break descriptor (e.g., the break descriptors 126 of FIG. 1) to identify the corresponding ad break 124 in the linear ad schedule information in the DAI schedule database 150. In addition, the DAI break enabler 102 accesses one or more DAI enablement rules in the DAI enablement rules database 140 based on, for example, date, time, television channel, programming content, etc. related to the ad break 124 identified in the linear ad schedule information. If the one or more DAI enablement rules indicate that dynamic ad selection should be enabled for the upcoming ad break 124 of the corresponding break descriptor 126, the DAI break enabler 102 enables the dynamic ad selection for the upcoming ad break 124 identified by the break descriptor 126. For example, the DAI break enabler 102 can set an enable code or value in the DAI schedule database 150 at a corresponding schedule entry for the upcoming ad break to indicate that a T2-level ad is to be presented by the STB 106 (FIG. 1) instead of (e.g., as a substitute for) a linear T3-level ad. Otherwise, the DAI break enabler 102 determines that dynamic ad selection for the upcoming ad break should not be enabled. As such, the DAI break enabler 102 does not enable dynamic ad selection for that upcoming ad break. In some examples, dynamic ad selection is disabled by default for an ad break based on the presence of a code, value, or indicator that a T3-level ad is to be presented for that ad break. In such examples, when the DAI break enabler 102 does not enable dynamic ad selection, dynamic ad selection remains disabled, according to its default state, and the STB 106 presents the T3-level ad or a T1-level ad, as determined by the STB 106.

The break identification controller 146 performs validations (e.g., substantially real-time validations) of dynamic ad selection enablement for upcoming ad breaks 124 against the schedule information in the DAI schedule database 150. For example, as part of processing GARs (e.g., the GAR 162 of FIG. 1) received at the ad routing service 144, the break identification controller 146 checks the schedule information in the DAI schedule database 150 to confirm whether the DAI break enabler 102 has enabled dynamic ad selection for corresponding ad breaks 124.

Although examples disclosed herein are described in association with one T2-level ad presented during an ad break 124, examples disclosed herein may be similarly implemented to select and present multiple T2-level ads during an ad break 124 in substitution for one or more T3-level ads delivered by the headend system 104 in the ad break 124.

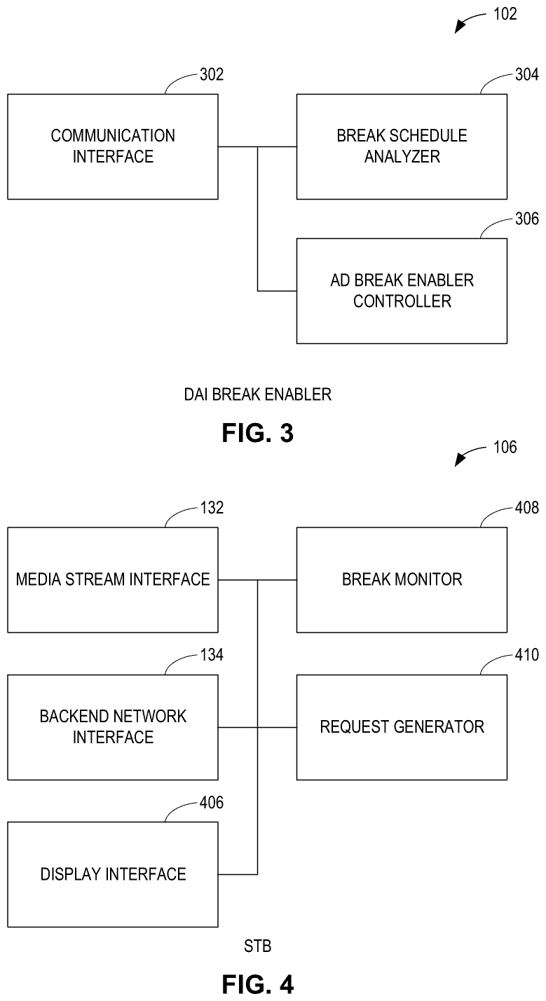

FIG. 3 is a block diagram of an example implementation of the DAI break enabler 102 of FIGS. 1 and 2 to enable dynamic ad selection of T2-level ads for upcoming ad breaks (e.g., the ad breaks 124 of FIG. 1). The DAI break enabler 102 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the DAI break enabler 102 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In example FIG. 3, the DAI break enabler 102 includes an example communication interface 302, an example break schedule analyzer 304, and an example ad break enabler controller 306. The communication interface 302 is provided to communicate with the ad routing service 144, the break identification controller 146, the linear ad scheduler 148, the DAI schedule database 150 of FIGS. 1 and 2, and the DAI UI 208 of FIG. 2. The break schedule analyzer 304 is provided to analyze schedule information from the DAI schedule database 150 (FIGS. 1 and 2). The ad break enabler controller 306 is provided to enable dynamic ad selection for ad breaks (e.g., the ad breaks 124 of FIG. 1) or to keep dynamic ad selection disabled based on DAI enablement rules in the DAI enablement rules database 140 and the linear ad schedule information in the DAI schedule database 150. For example, the ad break enabler controller 306 may generate a code or value indicative of whether dynamic ad selection of a T2-level ad is enabled or disabled for an ad break. In some examples, the ad break enabler controller 306 stores the code or value in association with a corresponding break identifier in the schedule information of the DAI schedule database 150. Additionally or alternatively, the ad break enabler controller 306 places the code or value in an ad decision such as the ad decision 172 of FIG. 1 to be communicated to the STB 106 (FIG. 1).

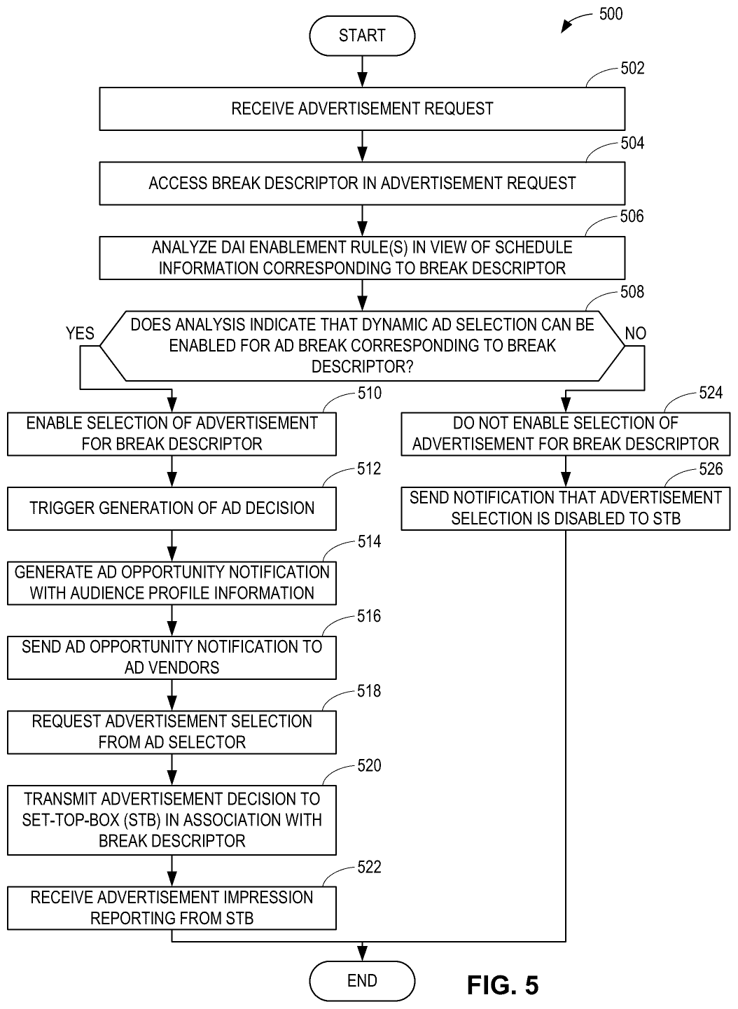

In some examples, the communication interface 302 is implemented by the communication interface circuitry and/or is instantiated by programmable circuitry executing communication interface instructions and/or configured to perform operations such as those represented by the flowchart of FIG. 5.

In some examples, the break schedule analyzer 304 is implemented by break schedule analyzer circuitry and/or is instantiated by programmable circuitry executing break schedule analyzer instructions and/or configured to perform operations such as those represented by the flowchart of FIG. 5.

In some examples, the ad break enabler controller 306 is implemented by ad break enabler controller circuitry and/or is instantiated by programmable circuitry executing ad break enabler controller instructions and/or configured to perform operations such as those represented by the flowchart of FIG. 5.

As described above, the communication interface 302, the break schedule analyzer 304, and the ad break enabler controller 306 of FIG. 3 are structures. Such structures may implement means for performing corresponding disclosed functions. Examples of such functions are described above in connection with corresponding ones of the communication interface 302, the break schedule analyzer 304, and the ad break enabler controller 306 and are described below in connection with the flowchart of FIG. 5.

While an example manner of implementing the DAI break enabler 102 of FIG. 1 is illustrated in FIG. 3, one or more of the elements, processes, and/or devices illustrated in FIG. 3 may be combined, divided, re-arranged, omitted, eliminated, and/or implemented in any other way. Further, the communication interface 302, the break schedule analyzer 304, the ad break enabler controller 306, and/or, more generally, the example DAI break enabler 102 of FIG. 3, may be implemented by hardware alone or by hardware in combination with software and/or firmware. Thus, for example, any of the communication interface 302, the break schedule analyzer 304, the ad break enabler controller 306, and/or, more generally, the example DAI break enabler 102, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example DAI break enabler 102 of FIG. 3 may include one or more elements, processes, and/or devices in addition to, or instead of, those illustrated in FIG. 3, and/or may include more than one of any or all of the illustrated elements, processes and devices.

FIG. 4 is a block diagram of an example implementation of the STB 106 of FIG. 1 to receive media streams (e.g., the media stream 118 of FIG. 1), monitor for ad breaks (e.g., the ad breaks 124 of FIG. 1) in the media streams, and send DAI requests (e.g., the DAI request 136) to the DAS system 110 of FIG. 1. The STB 106 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the STB 106 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In example FIG. 4, the STB 106 includes the example media stream interface 132, the example backend network interface 134, an example display interface 406, an example break monitor 408, and an example request generator 410. The media stream interface 132 is provided to receive media streams (e.g., the media stream 118) from the headend system 104 via the satellite network 108 of FIG. 1. The backend network interface 134 is provided to communicate with the DAS system 110 via the Internet 114 of FIG. 1. The display interface 406 is provided to send display information (e.g., video data, image data, text data, etc.) to the television or video monitor 107 (FIG. 1) connected to the STB 106.

The break monitor 408 is provided to monitor the incoming media stream 118 for upcoming occurrences of the ad breaks 124. For example, the break monitor 408 can monitor the media stream 118 for the break descriptors 126. In this manner, when the break monitor 408 detects a break descriptor 126, the break monitor 408 interprets the break descriptor 126 as corresponding to an upcoming ad break 124 in the media stream 118. The break descriptor 126 includes a break identifier corresponding to and identifying the upcoming ad break 124. The request generator 410 is provided to generate DAI requests such as the DAI request 136 of FIG. 1. For example, the request generator 410 can insert a break descriptor 126 into the DAI request 136 or insert a break identifier from the break descriptor 126 into the DAI request 136. The DAS system 110 can use the break descriptor 126 or the break identifier from the DAI request 136 to identify a corresponding one of the ad breaks 124 for which dynamic ad selection enablement is being requested by the STB 106.

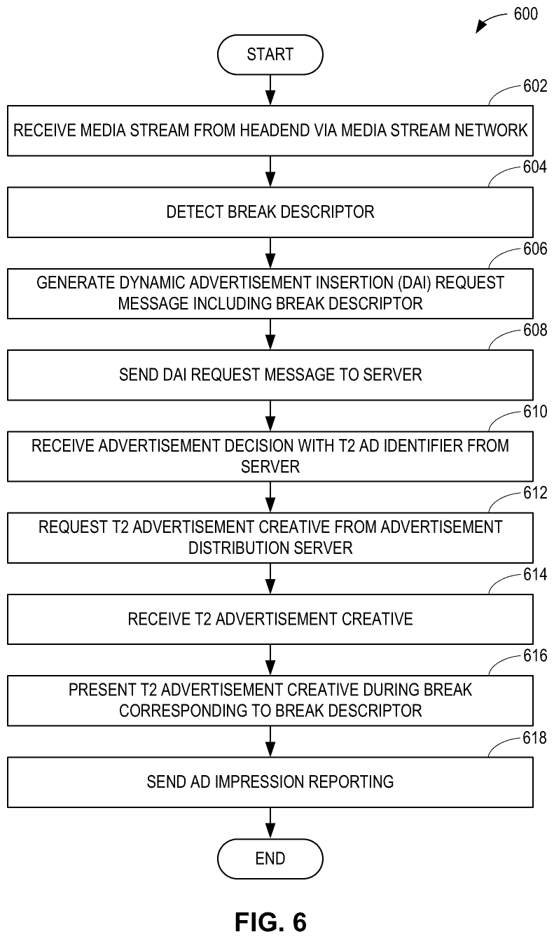

In some examples, the media stream interface 132 is implemented by media stream interface circuitry and/or is instantiated by programmable circuitry executing media stream interface instructions and/or configured to perform operations such as those represented by the flowchart of FIG. 6.

In some examples, the backend network interface 134 is implemented by backend network interface circuitry and/or is instantiated by programmable circuitry executing backend network interface instructions and/or configured to perform operations such as those represented by the flowchart of FIG. 6.

In some examples, the display interface 406 is implemented by display interface circuitry and/or is instantiated by programmable circuitry executing display interface instructions and/or configured to perform operations such as those represented by the flowchart of FIG. 6.

In some examples, the break monitor 408 is implemented by break monitor circuitry and/or is instantiated by programmable circuitry executing break monitor instructions and/or configured to perform operations such as those represented by the flowchart of FIG. 6.

In some examples, the request generator 410 is implemented by request generator circuitry and/or is instantiated by programmable circuitry executing request generator instructions and/or configured to perform operations such as those represented by the flowchart of FIG. 6.

As described above, the media stream interface 132, the backend network interface 134, the display interface 406, the break monitor 408, and the request generator 410 of FIG. 4 are structures. Such structures may implement means for performing corresponding disclosed functions. Examples of such functions are described above in connection with corresponding ones of the media stream interface 132, the backend network interface 134, the display interface 406, the break monitor 408, and the request generator 410 and are described below in connection with the flowchart of FIG. 6.

While an example manner of implementing the STB 106 of FIG. 1 is illustrated in FIG. 4, one or more of the elements, processes, and/or devices illustrated in FIG. 4 may be combined, divided, re-arranged, omitted, eliminated, and/or implemented in any other way. Further, the media stream interface 132, the backend network interface 134, the display interface 406, the break monitor 408, the request generator 410, and/or, more generally, the example STB 106 of FIG. 4, may be implemented by hardware alone or by hardware in combination with software and/or firmware. Thus, for example, any of the media stream interface 132, the backend network interface 134, the display interface 406, the break monitor 408, the request generator 410, and/or, more generally, the example STB 106, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example STB 106 of FIG. 4 may include one or more elements, processes, and/or devices in addition to, or instead of, those illustrated in FIG. 4, and/or may include more than one of any or all of the illustrated elements, processes and devices.

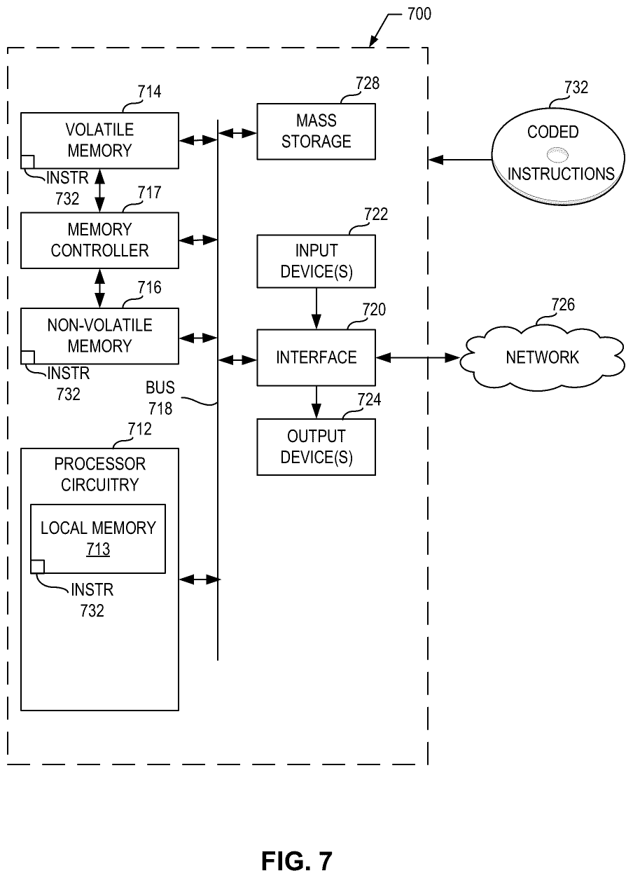

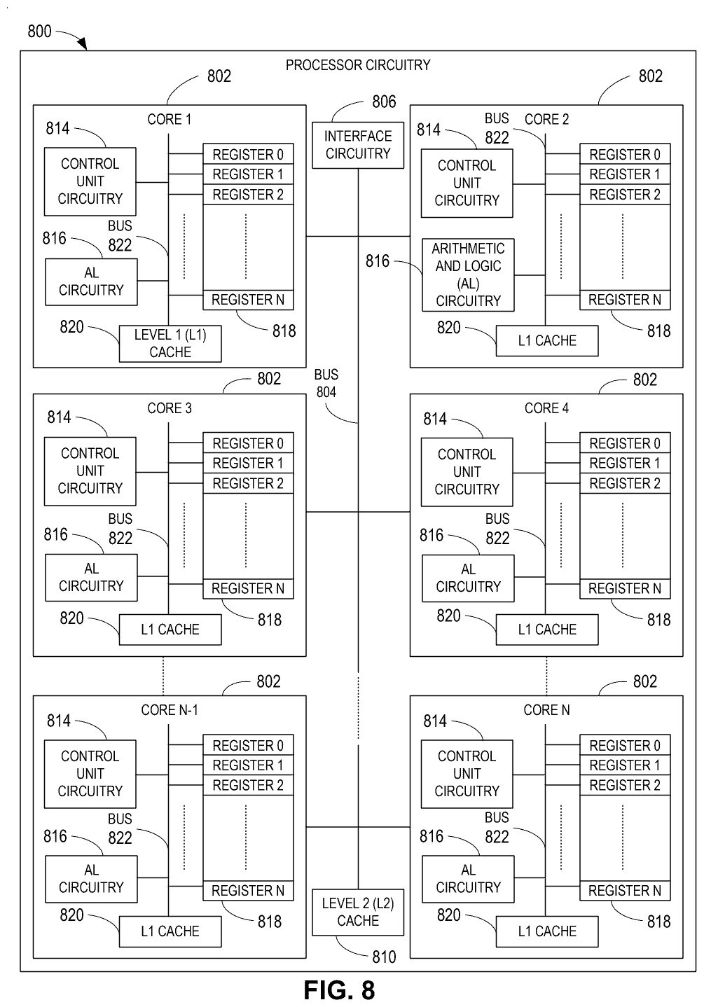

A flowchart representative of example machine-readable instructions, which may be executed by programmable circuitry to implement and/or instantiate the DAI break enabler 102 of FIG. 3 and/or representative of example operations which may be performed by programmable circuitry to implement and/or instantiate the DAI break enabler 102 of FIG. 3, is shown in FIG. 5. A flowchart representative of example machine-readable instructions, which may be executed by programmable circuitry to implement and/or instantiate the STB 106 of FIG. 4 and/or representative of example operations which may be performed by programmable circuitry to implement and/or instantiate the STB 106 of FIG. 4, is shown in FIG. 6. The machine-readable instructions may be executable programs or portions of executable programs for execution by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine-readable instructions cause an operation, a task, etc., to be carried out and/or performed in an automated manner in the real world. As used herein, “automated”means without human involvement.

The programs may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may programs and/or be executed by programmable circuitry located in one or more hardware devices, but the entirety of the programs and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example programs are described with reference to the flowcharts illustrated in FIGS. 5 and 6, many other methods of implementing the example DAI break enabler 102 and/or the STB 106 may alternatively be used. For example, the order of execution of the blocks of the flowcharts may be changed, and/or some of the blocks described may be changed, eliminated, or combined. Additionally or alternatively, any or all of the blocks of the flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as the programs described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding programs can be executed in whole or in part. Thus, machine-readable, computer-readable and/or machine-readable media, as used herein, may include instructions and/or programs regardless of the particular format or state of the machine-readable instructions and/or programs.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by example programmable circuitry to implement the DAI break enabler 102 of FIG. 3 to enable dynamic ad selection of T2-level ads for upcoming ad breaks (e.g., the ad breaks 124 of FIG. 1). The example machine-readable instructions and/or the example operations 500 of FIG. 5 begin at block 502, at which the communication interface 302 receives the general advertisement request (GAR) 162 (FIG. 1) corresponding to the STB 106 (FIG. 1). The GAR 162 is to cause selection of a T2-level advertisement to be inserted by the STB 106 in the media stream 118. For example, the communication interface 302 receives the GAR 162 from the ad request server 142 (FIG. 1) concurrent with the STB 106 receiving the media stream 118 (FIG. 1) from the headend system 104. As described above, the ad request server 142 receives the DAI request 136 from the backend network interface 134 of the STB 106 while the STB 106 is receiving the media stream 118 from the headend system 104 via the media stream interface 132. The ad request server 142 converts the DAI request 136 to the GAR 162 before the communication interface 302 of the DAI break enabler 102 receives the GAR 162.

At block 504, the break schedule analyzer 304 accesses a break descriptor (e.g., one of the break descriptors 126 of FIG. 1) from the GAR 162. For example, the break descriptor 126 corresponds to an upcoming one of the ad breaks 124 in the media stream 118. At block 506, the break schedule analyzer 304 analyzes one or more DAI enablement rule(s) in view of linear ad schedule information corresponding to the break descriptor 126.

The break schedule analyzer 304 accesses the DAI enablement rule(s) from the DAI enablement rules database 140 and accesses the linear ad schedule information corresponding to the break descriptor 126 from the DAI schedule database 150. For example, the break schedule analyzer 304 accesses the linear ad schedule information in the DAI schedule database 150 based on a break identifier from the break descriptor 126 that identifies an upcoming one of the ad breaks 124. In addition, the break schedule analyzer 304 may access the one or more DAI enablement rule(s) from the DAI enablement rules database 140 based on one or more characteristics of the retrieved linear ad schedule information corresponding to the break descriptor 126 such as television channel, programming content, date, day of week, time, etc.

At block 508, the break schedule analyzer 304 determines whether the analysis of block 506 indicates that dynamic ad selection can be enabled for the ad break 124 corresponding to the break descriptor 126. For example, the break schedule analyzer 304 determines whether the one or more DAI enablement rule(s) analyzed at block 506 in view of the linear ad schedule information for a break identifier from the break descriptor 126 indicates that a DAI enable indicator should be stored in the linear ad schedule information in association with the break descriptor 126 to allow the T2-level dynamic ad selection for the corresponding ad break 124. If the break schedule analyzer 304 determines that dynamic ad selection can be enabled for the ad break 124 based on the break descriptor 126 (block 508: YES), the ad break enabler controller 306 enables the dynamic ad selection for the break descriptor 126 (block 510). At block 512, the communication interface 302 triggers generation of an ad decision for the STB 106 by updating the schedule information for the break descriptor 126 in the DAI schedule database 150. For example, the communication interface 302 updates the schedule information to store a dynamic ad selection enable decision in association with a break identifier for the upcoming ad break 124.

At block 514, the ad routing service 144 generates an ad opportunity notification that includes audience profile information associated with the STB 106. At block 516, the ad routing service 144 sends the ad opportunity notification to ad vendors. For example, the ad routing service 144 sends the ad opportunity notification to the programmatic vendors 166 via the vendor APIs 156 of FIG. 1. At block 518, the ad routing service 144 requests an ad selection from the T2 ad selector 158 (FIG. 1). For example, the ad routing service 144 sends an ad campaign identifier provided by a programmatic vendor 166 to the T2 ad selector 158. The T2 ad selector 158 selects a T2-level ad identifier corresponding to the ad campaign identifier and provides it to the ad routing service 144.

At block 520, the ad request server 142 transmits the ad decision 172 (FIG. 1) to the STB 106 in association with the corresponding break descriptor 126. For example, the ad decision 172 includes the T2-level ad identifier (e.g., the T2-level ad identifier 168 of FIG. 1) to represent a T2-level ad (e.g., the T2-level ad 176 of FIG. 1) that is to be presented by the STB 106 during the upcoming ad break 124. The ad decision 172 may also include a URL of the advertisement distribution server 112 for use by the STB 106 to retrieve the T2-level ad 176 corresponding to the selected T2-level ad identifier 168. At block 522, the T2 ad selector 158 receives an advertisement impression reporting from the STB 106. For example, after the STB 106 presents the T2-level ad 176, the STB 106 sends an impression reporting message to the T2 ad selector 158 to report that the T2-level ad 176 was presented by the STB 106. The instructions and/or operations 500 of FIG. 5 end.

Referring again to block 508, if the break schedule analyzer 304 determines that dynamic ad selection cannot be enabled for the ad break 124 based on the break descriptor 126 (block 508: NO), the ad break enabler controller 306 does not enable the dynamic ad selection for the break descriptor 126 (block 524). In some examples, the ad break enabler controller 306 disables the dynamic ad selection for the break descriptor 126 by updating the linear ad schedule information in the DAI schedule database 150 to store a dynamic ad selection disable decision in association with a break identifier for the upcoming ad break 124. In other examples in which dynamic ad selection is disabled by default in the linear ad schedule information, the ad break enabler controller 306 does not make any changes in the schedule information at block 524 so that, for example, a T3-level ad status for the upcoming ad break 124 is maintained in the DAI schedule database 150.

In some examples, a first iteration of the instructions and/or operations 500 of FIG. 5 for a first break descriptor 126 corresponding to a first ad break 124 leads to enabling dynamic ad selection of a T2-level ad (e.g., as described above in connection with blocks 510, 512, 514, 516, 518, 520, and 522) and a second iteration of the instructions and/or operations 500 of FIG. 5 for a second break descriptor 126 corresponding to a second ad break 124 leads to not enabling dynamic ad selection (e.g., block 524). As such, examples disclosed herein may be used to handle selective enabling/disabling of dynamic ad selection of T2-level ads differently for different ones of the ad breaks 124 in the media stream 118.

At block 526, the ad request server 142 transmits a notification to the STB 106 indicating that dynamic ad selection is not enabled. For example, the notification may be the ad decision 172 with a message, code, or value indicative of a disabled dynamic ad selection for a T2-level ad. The instructions and/or operations 500 of FIG. 5 end.

FIG. 6 is a flowchart representative of example machine-readable instructions and/or example operations 600 that may be executed, instantiated, and/or performed by example programmable circuitry to implement the STB 106 of FIG. 4 to send the DAI request 136 (FIG. 1) to the DAS system 110 (FIG. 1) via the backend network interface 134 (FIGS. 1 and 4) while receiving the media stream 118 (FIG. 1) via the media stream interface 132 (FIGS. 1 and 4). The instructions and/or operations 600 begin at block 602 at which the media stream interface 132 receives the media stream 118 from the headend 104 via a media stream network such as the satellite network 108. As described above, the media stream 118 includes break descriptors 126 (FIG. 1) and corresponding ad breaks 124 (FIG. 1) that include T3-level advertisements. At block 604, the break monitor 408 (FIG. 4) detects one of the break descriptors 126 (FIG. 1) in the media stream 118. At block 606, the request generator 410 generates the DAI request message 136 and includes the break descriptor 126 in the DAI request message 136. The DAI request message 136 is to request selection of a T2-level advertisement.

At block 608, the backend network interface 134 sends the DAI request message 136 to the ad request server 142 (FIG. 1) via the Internet 114 (FIG. 1). At block 610, the backend network interface 134 receives the ad decision 172 (FIG. 1) with the T2-level ad identifier 168 from the ad request server 142. In examples disclosed herein, the backend network interface 134 receives the T2-level ad identifier 168 and a URL corresponding to the advertisement distribution server 112 in the ad decision 172. At block 612, the backend network interface 134 requests a T2-level ad creative from the advertisement distribution server 112. For example, the backend network interface 134 requests the T2-level ad creative based on the T2-level ad identifier 168 by using the URL to send the T2-level ad identifier 168 in a T2 advertisement request to the advertisement distribution server 112. The T2 advertisement request causes the advertisement distribution server 112 to return the T2-level ad creative 176 (FIG. 1) based on the T2-level ad identifier 168.

At block 614, the backend network interface 134 receives the T2-level ad creative 176 from the advertisement distribution server 112. At block 616, the display interface 406 (FIG. 4) presents the T2-level ad creative 176 during the ad break 124 in the media stream 118 corresponding to the break descriptor 126. At block 618, the backend network interface 134 sends an ad impression reporting message to the T2 ad selector 158 (FIG. 1). For example, the ad impression reporting message is to notify the T2 ad selector 158 that the STB 106 presented the T2-level ad creative 176. The instructions and/or operations 600 of FIG. 6 end.

FIG. 7 is a block diagram of an example programmable circuitry platform 700 structured to execute and/or instantiate the example machine-readable instructions and/or the example operations of FIG. 5 to implement the DAI break enabler 102 of FIG. 3. Alternatively, the example programmable circuitry platform 700 can be structured to execute and/or instantiate the example machine-readable instructions and/or the example operations of FIG. 6 to implement the STB 106 of FIG. 4. The programmable circuitry platform 700 can be, for example, a server, a personal computer, a workstation, a set top box, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In examples in which the programmable circuitry platform 700 is to implement the DAI break enabler 102, the programmable circuitry 712 implements the break schedule analyzer 304 and the ad break enabler controller 306 of FIG. 3. In examples in which the programmable circuitry platform 700 is to implement the STB 106, the programmable circuitry 712 implements the break monitor 408 and the request generator 410.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In examples in which the programmable circuitry platform 700 implements the STB 106, the interface circuitry 720 implements the display interface 406 (FIG. 4).

In the illustrated example, one or more input devices 722 are connected to the interface circuitry 720. The input device(s) 722 permit(s) a user (e.g., a human user, a machine user, etc.) to enter data and/or commands into the programmable circuitry 712. In examples in which the programmable circuitry platform 700 implements the STB 106 of FIG. 4, the input device(s) 722 can be implemented by, for example, an audio sensor, a microphone, a camera (still or video), a keyboard, a keypad, a remote control, and/or a voice recognition system.

One or more output devices 724 are also connected to the interface circuitry 720 of the illustrated example. In examples in which the programmable circuitry platform 700 implements the STB 106, the output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.) and/or speakers. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In examples in which the programmable circuitry platform 700 implements the DAI break enabler 102, the interface circuitry 720 implements the communication interface 302. In examples in which the programmable circuitry platform 700 implements the STB 106, the interface circuitry 720 implements the media stream interface 402 and another instance of interface circuitry of the programmable circuitry platform 700 implements the backend network interface 404.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented by the machine-readable instructions of FIGS. 5 and 6, may be stored in the mass storage device 728, in the volatile memory 714, in the non-volatile memory 716, and/or on at least one non-transitory computer-readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and 6 to effectively instantiate the circuitry of FIG. 2 as logic circuits to perform operations corresponding to those machine-readable instructions. In some such examples, the circuitry of FIGS. 3 and 4 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions and/or operations represented by the flowcharts of FIGS. 5 and 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

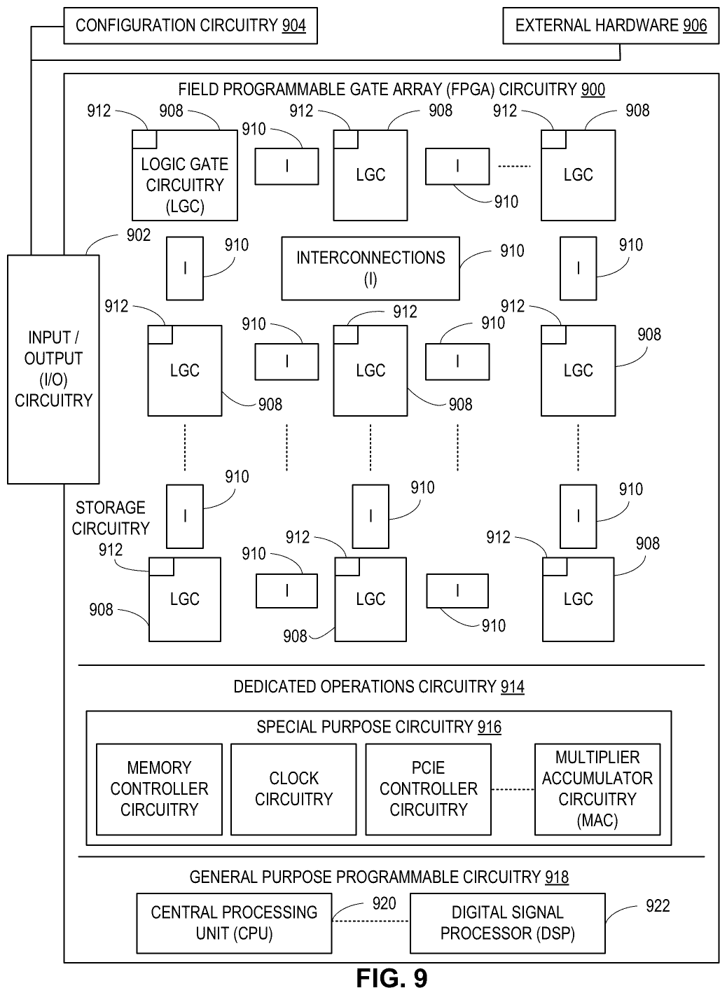

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine-readable instructions. However, once configured, the FPGA circuitry 900 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine-readable instructions represented by the flowcharts of FIGS. 5 and 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine-readable instructions represented by the flowcharts of FIGS. 5 and 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5 and 6. As such, the FPGA circuitry 900 may be configured and/or structured to effectively instantiate some or all of the operations/functions corresponding to the machine-readable instructions of the flowcharts of FIGS. 5 and 6 as dedicated logic circuits to perform the operations/functions corresponding to those software instructions in a dedicated manner analogous to an ASIC. Therefore, the FPGA circuitry 900 may perform the operations/functions corresponding to the some or all of the machine-readable instructions of FIGS. 5 and 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine-readable instructions of FIGS. 5 and 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine-readable instructions represented by the flowcharts of FIGS. 5 and 6 to perform first operation(s)/function(s), the FPGA circuitry 900 of FIG. 9 may be configured and/or structured to perform second operation(s)/function(s) corresponding to a second portion of the machine-readable instructions represented by the flowcharts of FIGS. 5 and 6, and/or an ASIC may be configured and/or structured to perform third operation(s)/function(s) corresponding to a third portion of the machine-readable instructions represented by the flowcharts of FIGS. 5 and 6.

It should be understood that some or all of the circuitry of FIGS. 3 and 4 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIGS. 3 and 4 may be instantiated, for example, in one or more threads executing concurrently and/or in series. For example, the microprocessor 800 of FIG. 8 may execute machine-readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIGS. 3 and 4 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real-time” refers to occurrence in a near instantaneous manner recognizing there may be real-world delays for computing time, transmission, etc. Thus, unless otherwise specified, “substantially real-time”refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that perform dynamic advertisement insertion in media streams. Disclosed systems, apparatus, articles of manufacture, and methods improve the efficiency of using a computing device by determining whether to enable dynamic ad selection in a media distribution system that includes a set-top-box having a media stream interface to receive a media stream from a headend and a separate backend network interface to request dynamic ad selection and substitute ads from a network resource to present in association with the media stream. By requesting substitute ads from the network resource, a storage capacity to locally store ads in the set-top-box can be reduced. Examples disclosed herein also allow reducing the amount of network bandwidth used to periodically update locally stored ads at the set-top-box by storing more ads at the separate network resource. Disclosed systems, apparatus, articles of manufacture, and methods are accordingly directed to one or more improvements in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A system comprising:
interface circuitry to receive a request corresponding to a set-top-box, the request received during receipt of a media stream at the set-top-box, the request to cause selection of an advertisement, the advertisement to be presented by the set-top-box during the media stream;
machine-readable instructions; and
at least one processor circuit to be programmed by the machine-readable instructions to:
access a break descriptor from the request, the break descriptor located in the media stream in advance of an upcoming break in the media stream;
based on the break descriptor, enable the selection of the advertisement for the upcoming break of the media stream; and
trigger generation of an advertisement decision for the set-top-box in association with the break descriptor, the advertisement decision to represent the advertisement.

2. The system of claim 1, wherein the interface circuitry is to receive the request from a server after the server receives a dynamic advertisement insertion request from the set-top-box via a first network, the set-top-box to receive the media stream via a second network from a headend.

3. The system of claim 2, wherein the first network is the Internet, the second network is a satellite network.

4. The system of claim 2, wherein the advertisement is a substitute advertisement, the break in the media stream including a linear advertisement received at the set-top-box from the second network, the substitute advertisement to be presented by the set-top-box instead of the linear advertisement.

5. The system of claim 1, wherein one or more of the at least one processor circuit is to, based on a second break descriptor corresponding to a second break in the media stream, not enable advertisement selection for the second break in the media stream.

6. The system of claim 1, wherein one or more of the at least one processor circuit is to obtain the advertisement decision based on an auctioning process, the auctioning process based on audience profile information corresponding to the set-top-box.

7. The system of claim 1, wherein the advertisement decision is to include a uniform resource locator (URL) and an advertisement identifier corresponding to the advertisement in the advertisement decision, the URL corresponding to an advertisement distribution server storing the advertisement.

8. The system of claim 1, wherein one or more of the at least one processor circuit is to enable the selection of the advertisement for the break of the media stream by:
accessing schedule information in a database;
analyzing a rule and the schedule information; and
based on the analysis, determining whether to associate a break identifier from the break descriptor with an indicator to allow the selection of the advertisement for the break.

9. A set-top-box comprising:
first interface circuitry to receive a media stream via a first network, the media stream including a break descriptor and a break, the break including a first advertisement;
second interface circuitry to be in communication with a server via a second network;
machine-readable instructions; and
at least one processor circuit to be programmed by the machine-readable instructions to:
generate a request message, the request message to include the break descriptor and to request selection of a second advertisement;
cause the second interface circuitry to send the request message to the server;
access a decision of the second advertisement from the server; and
cause presentation of the second advertisement during the break in the media stream.

10. The set-top-box of claim 9, wherein one or more of the at least one processor circuit is to substitute the first advertisement at the break in the media stream with the second advertisement.

11. The set-top-box of claim 9, wherein the first network is a satellite network and the second network is the Internet.

12. The set-top-box of claim 9, wherein one or more of the at least one processor circuit is to:
access a uniform resource locator (URL) and an advertisement identifier in the decision; and
cause the second interface circuitry to send an advertisement request to an advertisement distribution server using the URL, the advertisement request to cause the advertisement distribution server to return the second advertisement based on the advertisement identifier.

13. At least one non-transitory machine-readable medium comprising machine-readable instructions to cause at least one processor circuit to at least:
access a request corresponding to a set-top-box, the request received during receipt of a media stream at the set-top-box, the request to cause selection of an advertisement, the advertisement to be presented by the set-top-box during the media stream;
access a break descriptor from the request, the break descriptor corresponding to a located in the media stream in advance of an upcoming break in the media stream;
based on the break descriptor, enable the selection of the advertisement for the upcoming break of the media stream; and
trigger generation of an advertisement decision for the set-top-box in association with the break descriptor, the advertisement decision to represent the advertisement.

14. The at least one non-transitory machine-readable medium of claim 13, wherein the request is provided by a server after the server receives a dynamic advertisement insertion request from the set-top-box via a first network, the set-top-box to receive the media stream via a second network from a headend.

15. The at least one non-transitory machine-readable medium of claim 14, wherein the first network is the Internet, the second network is a satellite network.

16. The at least one non-transitory machine-readable medium of claim 14, wherein the advertisement is a substitute advertisement, the break in the media stream including a linear advertisement received at the set-top-box from the second network, the substitute advertisement to be presented by the set-top-box instead of the linear advertisement.

17. The at least one non-transitory machine-readable medium of claim 13, wherein the machine-readable instructions are to cause one or more of the at least one processor circuit to, based on a second break descriptor corresponding to a second break in the media stream, not enable advertisement selection for the second break in the media stream.

18. The at least one non-transitory machine-readable medium of claim 13, wherein the machine-readable instructions are to cause one or more of the at least one processor circuit to obtain the advertisement decision based on an auctioning process, the auctioning process based on audience profile information corresponding to the set-top-box.

19. The at least one non-transitory machine-readable medium of claim 13, wherein the advertisement decision is to include a uniform resource locator (URL) and an advertisement identifier corresponding to the advertisement in the advertisement decision, the URL corresponding to an advertisement distribution server storing the advertisement.

20. The at least one non-transitory machine-readable medium of claim 13, wherein the machine-readable instructions are to cause one or more of the at least one processor circuit to enable the selection of the advertisement for the break of the media stream by:
accessing schedule information;
analyzing a rule based on the schedule information; and
based on the analysis, determining whether to associate a break identifier from the break descriptor with an indicator to allow the selection of the advertisement for the break.
